(19) United States
(12) Patent Application Publication
(10) Pub. No.: US 2023/0302695 A1
(43) Pub. Date: Sep. 28, 2023

(54) INJECTION MOLDING MACHINE

(71) Applicant: THE JAPAN STEEL WORKS, LTD., Tokyo (JP)

(72) Inventors: Yusuke YONEHARA, Tokyo (JP); Yutaka NAKAGAWA, Tokyo (JP)

(21) Appl. No.: 18/126,422

(22) Filed: Mar. 25, 2023

(30) Foreign Application Priority Data
Mar. 28, 2022 (JP) 2022-052583

(51) Int. Cl. B29C 45/07

(52) U.S. Cl. CPC B29C 45/07

(57) ABSTRACT

An injection molding machine according to one embodiment includes a bed, an injection apparatus and a moving apparatus provided on the bed, and a hydraulic system for actuating the injection apparatus and the moving apparatus. The hydraulic system is provided with a hydraulic device group including a motor, a hydraulic pump, an oil tank, oil filters, and valves, and the hydraulic device group is arranged inside the bed.

### CROSS-REFERENCE TO RELATED APPLICATION

The present application claims priority from Japanese Patent Application No. 2022-052583 filed on Mar. 28, 2022, the contents of which are hereby incorporated by reference into this application.

### TECHNICAL FIELD OF THE INVENTION

The present invention relates to an injection molding machine including an apparatus powered by hydraulics.

### BACKGROUND OF THE INVENTION

An injection molding machine includes various types of apparatuses such as a mold clamping apparatus, an injection apparatus, and a moving apparatus. The injection molding machine further includes a hydraulic system composed of a plurality of hydraulic devices, and at least one apparatus of the injection molding machine is actuated by the hydraulic system (Japanese Unexamined Patent Application Publication No. 2009-255476 (Patent Document 1)).

### SUMMARY OF THE INVENTION

There is a demand for a reduction in the installation area of the entire injection molding machine including the hydraulic system.

Other problems and novel features will be apparent from the description of this specification and the accompanying drawings.

An injection molding machine according to one embodiment includes a bed, an injection apparatus and a moving apparatus provided on the bed, and a hydraulic system for actuating the injection apparatus and the moving apparatus. The hydraulic system is provided with a hydraulic device group including a motor, a hydraulic pump, an oil tank, oil filters, and valves, and the hydraulic device group is arranged inside the bed.

0007 According to one embodiment, it is possible to reduce the installation area of the entire injection molding machine including the hydraulic system.

### BRIEF DESCRIPTIONS OF THE DRAWINGS

FIG. 1 is a side view schematically showing an injection molding machine;

FIG. 2 is a plan view showing a part of the injection molding machine;

FIG. 3 is a plan view of an injection apparatus;

FIG. 4 is a system diagram showing a configuration of a hydraulic system;

FIG. 5 is an explanatory diagram showing a position of a hydraulic device group in a left-right direction;

FIG. 6A is a side view showing an operation side of a bed;

FIG. 6B is a side view showing a non-operation side of the bed;

FIG. 6C is a side view showing one end side of the bed in a longitudinal direction; and

FIG. 7 is a system diagram showing a modification of the configuration of the hydraulic system.

### DESCRIPTIONS OF THE PREFERRED EMBODIMENTS

Hereinafter, an embodiment will be described in detail with reference to drawings. Note that the members and devices having the same or substantially the same function are denoted by the same reference characters throughout the drawings for describing the embodiment, and the repetitive description thereof will be omitted in principle. Also, in order to prevent the drawings from being complicated, members and devices shown in some drawings may be omitted in other drawings in some cases.

### Injection Molding Machine

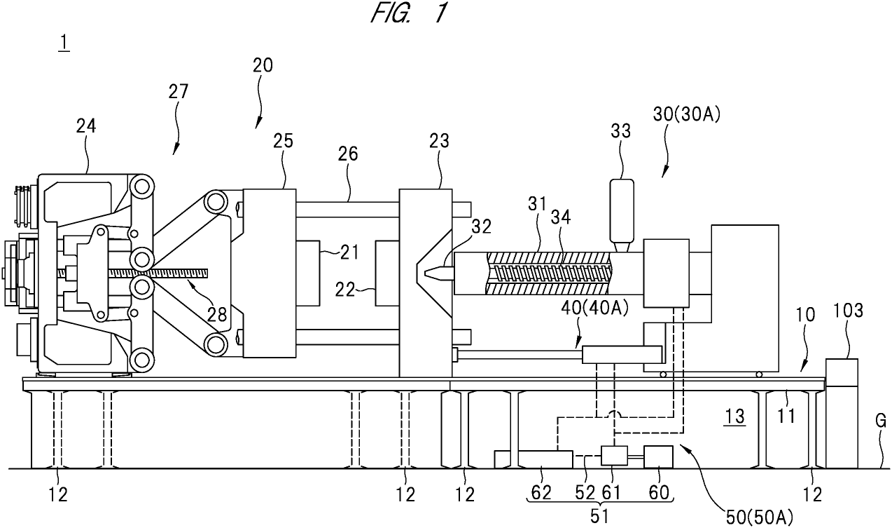

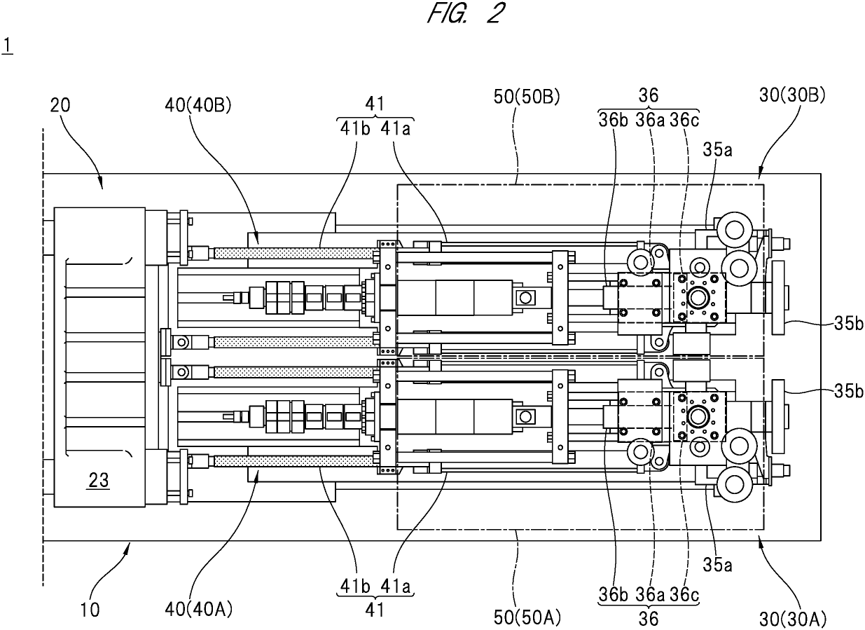

FIG. 1 is a side view schematically showing an injection molding machine 1 according to the present embodiment. FIG. 2 is a plan view showing a part of the injection molding machine 1 according to the present embodiment.

The injection molding machine 1 includes a bed 10, a mold clamping apparatus 20, an injection apparatus 30, and a moving apparatus 40 provided on the bed 10, and a hydraulic system 50 for actuating the injection apparatus 30 and the moving apparatus 40. More specifically, the injection molding machine 1 includes a bed 10, a mold clamping apparatus 20, injection apparatuses 30A and 30B, moving apparatuses 40A and 40B, and hydraulic systems 50A and 50B. From another point of view, the injection molding machine 1 includes a set of injection apparatus 30A, moving apparatus 40A, and hydraulic system 50A and another set of injection apparatus 30B, moving apparatus 40B, and hydraulic system 50B. Namely, the injection molding machine 1 according to the present embodiment is a twin injection molding machine.

Although not shown, a control panel (controller) operated by a worker is provided on the side of the injection molding machine 1 shown in FIG. 1. Therefore, of the two sides of the injection molding machine 1, the side shown in FIG. 1 is the “operation side”, and the side opposite to the side shown in FIG. 1 is the “non-operation side”.

The injection apparatus 30A, the moving apparatus 40A, and the hydraulic system 50A shown in FIG. 2 are provided on the operation side, and the injection apparatus 30B, the moving apparatus 40B, and the hydraulic system 50B shown in FIG. 2 are provided on the non-operation side. Furthermore, the injection apparatus 30A and others on the operation side and the injection apparatus 30B and others on the non-operation side are arranged in parallel to each other.

The injection apparatus 30A and the injection apparatus 30B are the same or substantially the same apparatuses. Also, the moving apparatus 40A and the moving apparatus 40B are the same or substantially the same apparatuses. Furthermore, the hydraulic system 50A and the hydraulic system 50B are the same or substantially the same systems.

Therefore, in the following description, when the injection apparatus 30A and the injection apparatus 30B are not particularly distinguished, they may be collectively referred to as the “injection apparatus 30”. Also, when the moving apparatus 40A and the moving apparatus 40B are not particularly distinguished, they may be collectively referred to as the “moving apparatus 40”. Furthermore, when the hydraulic system 50A and the hydraulic system 50B are not particularly distinguished, they may be collectively referred to as the “hydraulic system 50”.

Now refer to FIG. 1 again. Molds 21 and 22 are attached to the mold clamping apparatus 20 of the injection molding machine 1. The mold clamping apparatus 20 opens and closes the attached molds 21 and 22. The injection apparatus 30 heats and melts a metal material (for example, magnesium or magnesium alloy). The injection apparatus 30 injects the molten metal material (molten metal) into the molds 21 and 22 attached to the mold clamping apparatus 20. More specifically, the injection apparatus 30 injects the molten metal into a cavity of the molds 21 and 22. Namely, the injection molding machine 1 according to the present embodiment is a metal injection molding machine.

### Bed

The bed 10 has a top plate 11 on which the mold clamping apparatus 20, the injection apparatus 30, and the moving apparatus 40 are mounted and a plurality of support legs 12 that support the top plate 11. The top plate 11 has a substantially rectangular planar shape. The mold clamping apparatus 20 is arranged on one end side of the top plate 11 in the longitudinal direction, and the injection apparatus 30 is arranged on the other end side of the top plate 11 in the longitudinal direction. Also, the moving apparatus 40 is interposed between the mold clamping apparatus 20 and the injection apparatus 30. In addition, in the following description, the longitudinal direction of the top plate 11 may be referred to as “front-back direction”. Also, the direction orthogonal to the longitudinal direction of the top plate 11 may be referred to as “width direction” or “left-right direction”. From another point of view, one side in the width direction is the operation side, and the other side in the width direction is the non-operation side.

The support legs 12 are arranged on the back side of the top plate 11 and support the top plate 11. A plurality of support legs 12 are arranged along the front-back direction on at least the left and right sides of the top plate 11. The top plate 11 supported from below by the support legs 12 is separated from a floor G by a distance corresponding to the length of the support legs 12. As a result, a space surrounded by the plurality of support legs 12 is present between the floor G and the top plate 11. From another point of view, an installation space 13 in which hydraulic devices and the like which will be described later are arranged is provided below the top plate 11 and inside the support legs 12. Note that the bed 10 according to the present embodiment is made disassemblable in consideration of the convenience of transportation and delivery to a factory.

### Mold Clamping Apparatus

The mold clamping apparatus 20 includes a fixed platen 23, a mold clamping housing 24, and a movable platen 25 provided on the bed 10. The fixed platen 23 and the mold clamping housing 24 are fixed to the bed 10. On the other hand, the movable platen 25 is movable above the bed 10 in the front-back direction.

The fixed platen 23 and the mold clamping housing 24 are connected to each other by a plurality of tie bars 26 penetrating through the movable platen 25. More specifically, the fixed platen 23 and the mold clamping housing 24 are connected by four tie bars 26. The movable platen 25 is movable between the fixed platen 23 and the mold clamping housing 24 in the opposing direction thereof (front-back direction).

A link-type mold clamping mechanism 27 driven by a servomotor is provided between the mold clamping housing 24 and the movable platen 25. From another point of view, a toggle mechanism driven by a servomotor is provided between the mold clamping housing 24 and the movable platen 25.

The mold clamping mechanism 27 includes a ball screw 28 rotationally driven by a servomotor and moves the mold 21 attached to the movable platen 25 forward and backward with respect to the mold 22 attached to the fixed platen 23. When the mold 21 comes in contact with the mold 22, the molds 21 and 22 are closed. On the other hand, when the mold 21 is separated from the mold 22, the molds 21 and 22 are opened. The mold clamping mechanism 27 can press the mold 21 to the mold 22 such that the molds 21 and 22 do not open while the molds 21 and 22 are closed. Note that the mold clamping mechanism 27 can be replaced with a direct pressure type.

### Injection Apparatus

The injection apparatus 30 is composed of a heating cylinder 31, an injection nozzle 32, and the like. The injection apparatus 30 is provided so as to be movable on the bed 10 and is reciprocally driven by the moving apparatus 40. More specifically, the injection apparatus 30 is driven by the moving apparatus 40 not only in a direction toward the mold clamping apparatus 20 (forward direction) but also in a direction away from the mold clamping apparatus 20 (backward direction). In other words, the injection apparatus 30 moves forward and backward with respect to the mold clamping apparatus 20. When the injection apparatus 30 moves forward to a predetermined position, a tip of the injection nozzle 32 comes in contact with a sprue bush of the mold 22.

A hopper 33 is provided on a rear end side of the heating cylinder 31. The hopper 33 is a supply port for supplying a metal material into the heating cylinder 31. A screw 34 is provided inside the heating cylinder 31.

The screw 34 is driven inside the heating cylinder 31. More specifically, the screw 34 is rotationally driven inside the heating cylinder 31. Further, the screw 34 is linearly driven inside the heating cylinder 31. The direction in which the screw 34 is linearly driven is the same as the moving direction of the injection apparatus 30 with respect to the mold clamping apparatus 20. Namely, the screw 34 is linearly driven inside the heating cylinder 31 in the direction toward the mold clamping apparatus 20 (forward direction) and the direction away from the mold clamping apparatus 20 (backward direction).

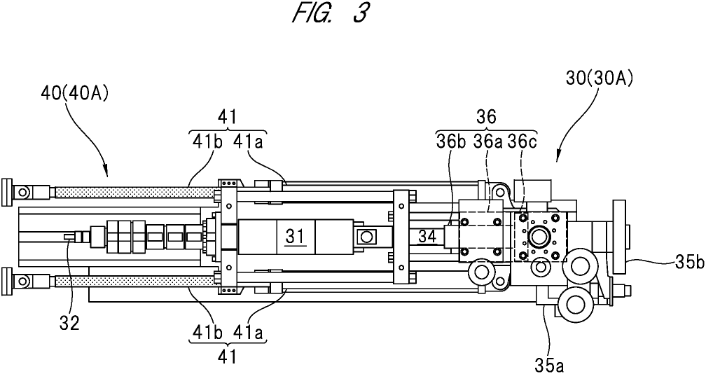

FIG. 3 is a plan view of the injection apparatus 30A. As described above, the injection apparatus 30A and the injection apparatus 30B are the same or substantially the same apparatuses. Thus, the details of the injection apparatus 30B will also be apparent by describing the details of the injection apparatus 30A mainly with reference to FIG. 3.

The screw 34 of the injection apparatus 30A is rotationally driven by a servomotor 35a. The rotational driving force output from the servomotor 35a is transmitted to the screw 34 via a pulley 35b and the like.

The injection apparatus 30A includes a hydraulic cylinder 36 arranged behind the screw 34. The hydraulic cylinder 36 has a cylinder tube 36a and a piston rod 36b, and the piston rod 36b moves with respect to the cylinder tube 36a by the pressure (hydraulic pressure) of hydraulic fluid supplied to the cylinder tube 36a.

A tip of the piston rod 36b of the hydraulic cylinder 36 is connected to the screw 34. Therefore, when the piston rod 36b is pushed out of the cylinder tube 36a, the screw 34 is driven forward inside the heating cylinder 31. On the other hand, when the piston rod 36b is pulled into the cylinder tube 36a, the screw 34 is driven backward inside the heating cylinder 31.

The heating cylinder 31 melts the supplied metal material to make molten metal. A heater for heating the heating cylinder 31 is provided around the heating cylinder 31. In the present embodiment, a plurality of band heaters are wound around the outer peripheral surface of the heating cylinder 31. The metal material supplied to the heating cylinder 31 is heated and melted by the heat generated from the band heater and the shearing heat generated by the rotation of the screw 34.

### Moving Apparatus

Next, the details of the moving apparatus 40A will be described mainly with reference to FIG. 3. As described above, the moving apparatus 40A and the moving apparatus 40B are the same or substantially the same apparatuses. Therefore, the following description of the moving apparatus 40A is also the description of the moving apparatus 40B.

The moving apparatus 40A includes a pair of hydraulic cylinders 41 arranged on both left and right sides of the heating cylinder 31. The pair of hydraulic cylinders 41 are parallel to each other and are parallel also to the heating cylinder 31.

Each hydraulic cylinder 41 includes a cylinder tube 41a and a piston rod 41b. The piston rod 41b moves with respect to the cylinder tube 41a by the pressure (hydraulic pressure) of hydraulic fluid supplied to the cylinder tube 41a. In FIG. 2 and FIG. 3, hatching (dot pattern) is applied to the piston rod 41b in order to clarify the piston rod 41b.

A tip of the piston rod 41b of each hydraulic cylinder 41 is fixed to the fixed platen 23 of the mold clamping apparatus 20 (FIG. 2). On the other hand, the cylinder tube 41a of each hydraulic cylinder 41 is fixed to the injection apparatus 30. Therefore, when the piston rod 41b is pushed out of the cylinder tube 41a, the injection apparatus 30 is driven backward. Namely, the injection apparatus 30 moves backward and is separated from the mold clamping apparatus 20. On the other hand, when the piston rod 41b is pulled into the cylinder tube 41a, the injection apparatus 30 is driven forward. Namely, the injection apparatus 30 moves forward and approaches the mold clamping apparatus 20.

### Manufacturing Method of Molded Product

The process for manufacturing a molded product such as a metal member by the use of the injection molding machine 1 is the same or substantially the same as the known process. Therefore, detailed description of the manufacturing process is omitted, but the manufacturing process includes one or two more of the following steps.
(Step 1) A step of actuating the moving apparatus 40 by the hydraulic system 50 to move the injection apparatus 30 backward.
(Step 2) A step of actuating the moving apparatus 40 by the hydraulic system 50 to move the injection apparatus 30 forward.
(Step 3) A step of actuating the injection apparatus 30 by the hydraulic system 50 to move the screw 34 forward inside the heating cylinder 31.
(Step 4) A step of recovering all or part of the hydraulic fluid supplied to the injection apparatus 30 and the moving apparatus 40 to the hydraulic system 50.

### Hydraulic System

As described above, the hydraulic system 50 actuates at least the injection apparatus 30 and the moving apparatus 40. From another point of view, the hydraulic system 50 supplies hydraulic fluid to the injection apparatus 30 and the moving apparatus 40 as needed, and recovers the hydraulic fluid therefrom. More specifically, the hydraulic system 50 supplies hydraulic fluid to the hydraulic cylinder 36 of the injection apparatus 30 and recovers the hydraulic fluid from the hydraulic cylinder 36. Also, the hydraulic system 50 supplies hydraulic fluid to the hydraulic cylinder 41 of the moving apparatus 40 and recovers the hydraulic fluid from the hydraulic cylinder 41.

### Hydraulic Device Group and Flow Path

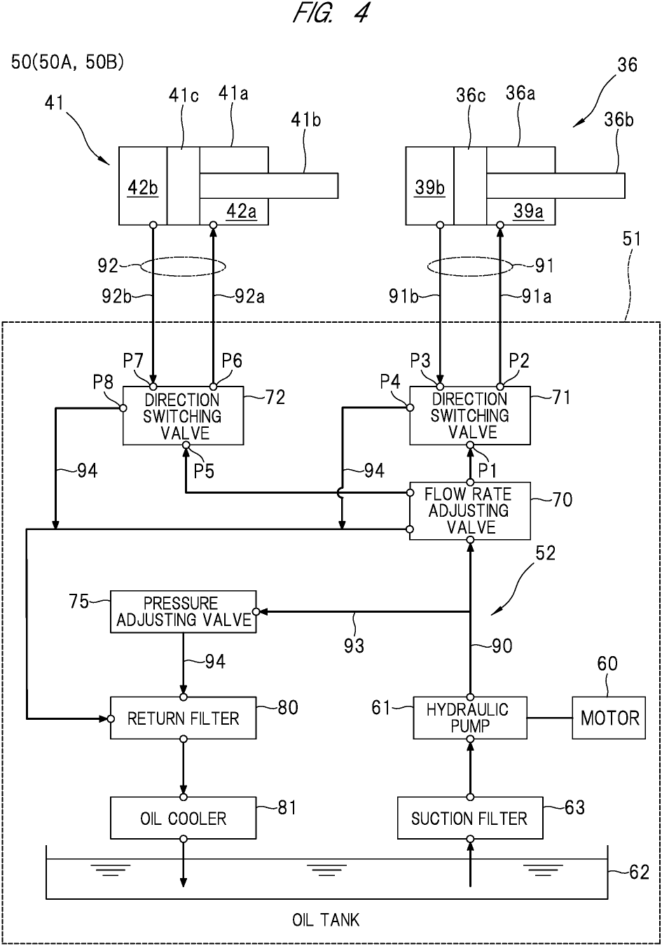

FIG. 4 is a system diagram showing a configuration of the hydraulic system 50. The hydraulic system 50 is composed of, for example, a hydraulic device group 51 including a plurality of hydraulic devices and a pipe 52 constituting a flow path (fluid path) of the hydraulic fluid.

Here, the cylinder tube 36a of each hydraulic cylinder 36 is divided into a front chamber 39a and a rear chamber 39b. Specifically, the internal space of the cylinder tube 36a is divided into the front chamber 39a and the rear chamber 39b by a piston 36c provided at the rear end of the piston rod 36b.

When hydraulic fluid is supplied to the front chamber 39a, the piston rod 36b is pulled into the cylinder tube 36a by the hydraulic pressure acting on the front surface of the piston 36c, and the hydraulic fluid is discharged from the rear chamber 39b. On the other hand, when hydraulic fluid is supplied to the rear chamber 39b, the piston rod 36b is pushed out of the cylinder tube 36a by the hydraulic pressure acting on the back surface of the piston 36c, and the hydraulic fluid is discharged from the front chamber 39a.

Further, the cylinder tube 41a of each hydraulic cylinder 41 is divided into a front chamber 42a and a rear chamber 42b. Specifically, the internal space of the cylinder tube 41a is divided into the front chamber 42a and the rear chamber 42b by a piston 41c provided at the rear end of the piston rod 41b.

When hydraulic fluid is supplied to the front chamber 42a, the piston rod 41b is pulled into the cylinder tube 41a by the hydraulic pressure acting on the front surface of the piston 41c, and the hydraulic fluid is discharged from the rear chamber 42b. On the other hand, when hydraulic fluid is supplied to the rear chamber 42b, the piston rod 41b is pushed out of the cylinder tube 41a by the hydraulic pressure acting on the back surface of the piston 41c, and the hydraulic fluid is discharged from the front chamber 42a.

The hydraulic device group 51 constituting the hydraulic system 50 includes a motor 60, a hydraulic pump 61, an oil tank 62, and an oil filter (suction filter 63). The motor 60 is an electric motor. More specifically, the motor 60 is a three-phase induction motor and drives at least the hydraulic pump 61. The hydraulic pump 61 pressurizes hydraulic fluid to circulate it in the hydraulic system 50. The oil tank 62 stores all or part of the hydraulic fluid circulating in the hydraulic system 50. The suction filter 63 is provided between the oil tank 62 and the hydraulic pump 61 and removes foreign matter and others from the hydraulic fluid flowing into the hydraulic pump 61.

The hydraulic device group 51 further includes a plurality of valves. More specifically, the hydraulic device group 51 includes a flow rate adjusting valve 70, a direction switching valve 71 for injection apparatus, a direction switching valve 72 for moving apparatus, and a pressure adjusting valve 75.

The hydraulic device group 51 also includes an oil filter (return filter 80) and an oil cooler 81. The return filter 80 and the oil cooler 81 are arranged in this order between the pressure adjusting valve 75 and the oil tank 62.

The pipe 52 constituting the hydraulic system 50 includes a common pipe 90, a pipe 91 for injection apparatus, a pipe 92 for moving apparatus, a branch pipe 93, and a return pipe 94.

The common pipe 90 forms a flow path (common flow path) from the oil tank 62 to the flow rate adjusting valve 70 via the suction filter 63 and the hydraulic pump 61.

The pipe 91 for injection apparatus forms a flow path (flow path for injection apparatus) for supplying hydraulic fluid to the injection apparatus 30 and recovering the hydraulic fluid from the injection apparatus 30. More specifically, the pipe 91 for injection apparatus forms a flow path for supplying hydraulic fluid to the hydraulic cylinder 36 and recovering the hydraulic fluid from the hydraulic cylinder 36.

Further, the pipe 91 for injection apparatus includes a pipe 91a for injection apparatus connected to the front chamber 39a of the cylinder tube 36a and a pipe 91b for injection apparatus connected to the rear chamber 39b of the cylinder tube 36a.

The pipe 92 for moving apparatus forms a flow path (flow path for moving apparatus) for supplying hydraulic fluid to the moving apparatus 40 and recovering the hydraulic fluid from the moving apparatus 40. More specifically, the pipe 92 for moving apparatus forms a flow path for supplying hydraulic fluid to the hydraulic cylinder 41 and recovering the hydraulic fluid from the hydraulic cylinder 41.

Further, the pipe 92 for moving apparatus includes a pipe 92a for moving apparatus connected to the front chamber 42a of the cylinder tube 41a and a pipe 92b for moving apparatus connected to the rear chamber 42b of the cylinder tube 41a.

The branch pipe 93 forms a flow path (branch flow path) that branches from a flow path (common flow path) connecting the hydraulic pump 61 and the flow rate adjusting valve 70 and reaches the pressure adjusting valve 75.

The return pipe 94 forms a flow path (return flow path) for returning the hydraulic fluid discharged from the injection apparatus 30 or the moving apparatus 40 or the hydraulic fluid that has passed through the pressure adjusting valve 75 to the oil tank 62.

### Basic Operation of Hydraulic System

The hydraulic pump 61 delivers the hydraulic fluid sucked from the oil tank 62. The hydraulic pump 61 delivers a constant amount of hydraulic fluid at constant pressure. The hydraulic fluid delivered from the hydraulic pump 61 flows through the branch pipe 93 to the pressure adjusting valve 75.

The pressure adjusting valve 75 is a proportional valve. The pressure adjusting valve 75 adjusts the pressure of hydraulic fluid flowing through the flow rate adjusting valve 70 to a set pressure. From another point of view, the pressure adjusting valve 75 maintains the pressure of hydraulic fluid in the common flow path and the branch flow path at the set pressure.

The flow rate adjusting valve 70 is a proportional valve. The flow rate adjusting valve 70 distributes the hydraulic fluid whose pressure has been adjusted by the pressure adjusting valve 75 to the injection apparatus 30 and the moving apparatus 40. More specifically, the flow rate adjusting valve 70 causes a set amount of hydraulic fluid to flow through the direction switching valve 71 connected to one end of the pipe 91 for injection apparatus and the direction switching valve 72 connected to one end of the pipe 92 for moving apparatus.

The direction switching valve 71 is a solenoid type two-way switching valve and has a plurality of ports. Specifically, the direction switching valve 71 has a port P1 to which the pipe leading to the flow rate adjusting valve 70 is connected, a port P2 to which the pipe 91a for injection apparatus is connected, a port P3 to which the pipe 91b for injection apparatus is connected, and a port P4 to which the return pipe 94 is connected.

The direction switching valve 71 is switched to a position (neutral position) where all ports are closed, a position where the ports P1 and P2 are in communication and the ports P3 and P4 are in communication, and a position where the ports P1 and P3 are in communication and the ports P2 and P4 are in communication.

When the ports P1 and P2 are in communication and the ports P3 and P4 are in communication, hydraulic fluid flows into the front chamber 39a of the cylinder tube 36a through the pipe 91a for injection apparatus. Then, the piston rod 36b is pulled into the cylinder tube 36a, and the hydraulic fluid is discharged from the rear chamber 39b. The hydraulic fluid discharged from the rear chamber 39b flows into the return pipe 94 through the pipe 91b for injection apparatus and the direction switching valve 71 (ports P3, P4).

On the other hand, when the ports P1 and P3 are in communication and the ports P2 and P4 are in communication, hydraulic fluid flows into the rear chamber 39b of the cylinder tube 36a through the pipe 91b for injection apparatus. Then, the piston rod 36b is pushed out of the cylinder tube 36a, and the hydraulic fluid is discharged from the front chamber 39a. The hydraulic fluid discharged from the front chamber 39a flows into the return pipe 94 through the pipe 91a for injection apparatus and the direction switching valve 71 (ports P2, P4).

The direction switching valve 72 is a two-way switching valve similar to the direction switching valve 71. The direction switching valve 72 has a port P5 to which the pipe leading to the flow rate adjusting valve 70 is connected, a port P6 to which the pipe 92a for moving apparatus is connected, a port P7 to which the pipe 92b for moving apparatus is connected, and a port P8 to which the return pipe 94 is connected.

The direction switching valve 72 is switched to a position (neutral position) where all ports are closed, a position where the ports P5 and P6 are in communication and the ports P7 and P8 are in communication, and a position where the ports P5 and P7 are in communication and the ports P6 and P8 are in communication.

When the ports P5 and P6 are in communication and the ports P7 and P8 are in communication, hydraulic fluid flows into the front chamber 42a of the cylinder tube 41a through the pipe 92a for moving apparatus. Then, the piston rod 41b is pulled into the cylinder tube 41a, and the hydraulic fluid is discharged from the rear chamber 42b. The hydraulic fluid discharged from the rear chamber 42b flows into the return pipe 94 through the pipe 92b for moving apparatus and the direction switching valve 72 (ports P7, P8).

On the other hand, when the ports P5 and P7 are in communication and the ports P6 and P8 are in communication, hydraulic fluid flows into the rear chamber 42b of the cylinder tube 41a through the pipe 92b for moving apparatus. Then, the piston rod 41b is pushed out of the cylinder tube 41a, and the hydraulic fluid is discharged from the front chamber 42a. The hydraulic fluid discharged from the front chamber 42a flows into the return pipe 94 through the pipe 92a for moving apparatus and the direction switching valve 72 (ports P6, P8).

The hydraulic fluid discharged from the hydraulic cylinders 36 and 41 and flowing into the return pipe 94 passes through the return filter 80 and the oil cooler 81 in this order and returns to the oil tank 62. At this time, foreign matters and the like contained in the hydraulic fluid are captured by the return filter 80. Also, the hydraulic fluid is cooled by heat exchange by the oil cooler 81.

### Arrangement of Hydraulic Device Group

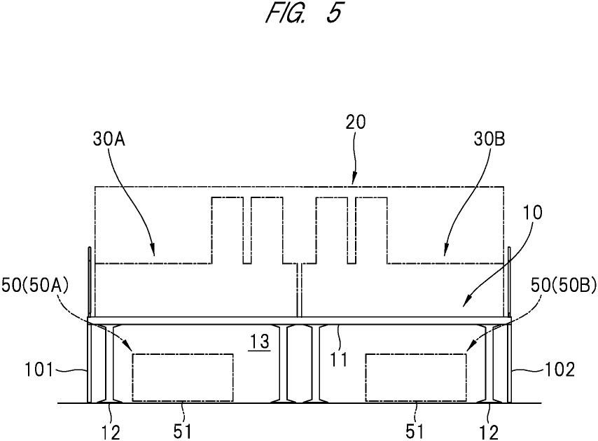

FIG. 5 is an explanatory diagram showing a position of the hydraulic device group 51 in the left-right direction. As shown in FIG. 1 and FIG. 5, the hydraulic device group 51 is arranged inside the bed 10. More specifically, the hydraulic device group 51 is arranged in the installation space 13 provided below the top plate 11 and inside the support legs 12. From another point of view, the hydraulic device group 51 is arranged between a row of support legs 12 located on the right side (operation side) of the top plate 11 and a row of support legs 12 located on the left side (non-operation side) of the top plate 11.

Furthermore, the hydraulic device group 51 constituting the hydraulic system 50A is arranged below the region of the top plate 11 where the injection apparatus 30A is mounted. Also, the hydraulic device group 51 constituting the hydraulic system 50B is arranged below the region of the top plate 11 where the injection apparatus 30B is mounted.

Namely, in the injection molding machine 1 according to the present embodiment, of the plurality of hydraulic devices constituting the hydraulic system 50, at least the hydraulic devices included in the hydraulic device group 51 shown in FIG. 4 are arranged inside the bed 10.

Therefore, it is not necessary to secure around the bed 10 a space for installing the hydraulic devices included in the hydraulic device group 51. As a result, the installation area of the injection molding machine 1 including the hydraulic system 50 is reduced.

### Cover and Control Panel

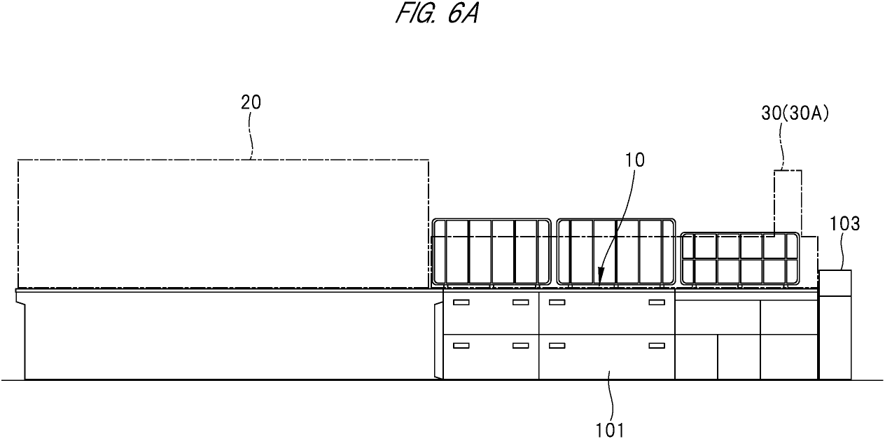

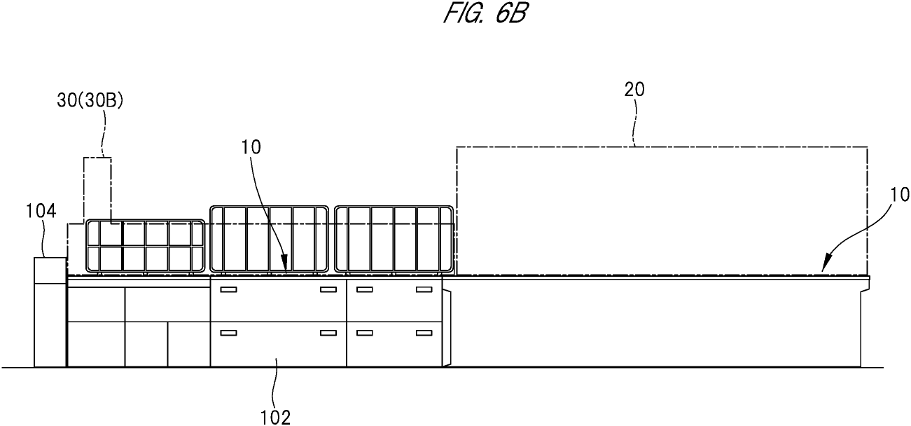

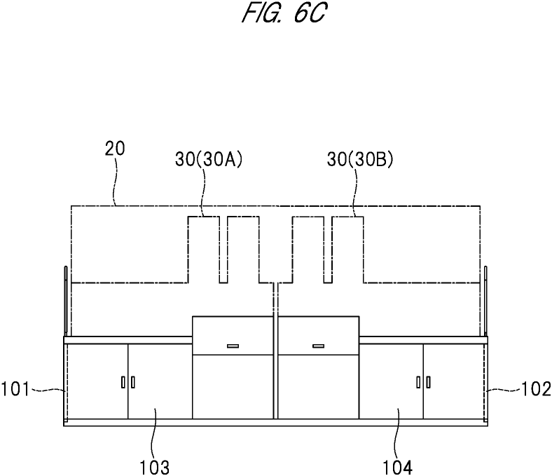

FIG. 6A is a side view showing an operation side (right side) of the bed 10. FIG. 6B is a side view showing a non-operation side (left side) of the bed 10. FIG. 6C is a side view showing one end side of the bed 10 in the longitudinal direction.

A pair of covers 101 and 102 facing with the hydraulic device group 51 (FIG. 5) interposed therebetween are provided on both sides (operation side and non-operation side) of the top plate 11. Also, control units 103 and 104 are provided between one end side of one cover 101 in the longitudinal direction and one of end side of the other cover 102 in the longitudinal direction.

The control unit 103 accommodates various control boards for controlling the apparatuses on the operation side such as the injection apparatus 30A and the moving apparatus 40A. On the other hand, the control unit 104 accommodates various control boards for controlling the apparatuses on the non-operation side such as the injection apparatus 30B and the moving apparatus 40B.

The control units 103 and 104 are arranged side by side in the left-right direction and are adjacent to each other with almost no gap. As a result, three sides of the installation space 13 (FIG. 1, FIG. 5) in which the hydraulic device group 51 is arranged are closed by the covers 101 and 102 and the control units 103 and 104. From another point of view, three sides of the space below the top plate 11 are closed by the covers 101 and 102 and the control units 103 and 104.

Therefore, the operating sound of the hydraulic device group 51 is less likely to leak out of the bed 10, and the noise of the injection molding machine 1 is reduced. Namely, the covers 101 and 102 and the control units 103 and 104 function as soundproof walls or sound insulation walls.

Note that the covers 101 and 102 are fixed to the bed 10 with bolts and can be removed as necessary. It is also possible to improve the soundproofing effect and the sound insulation effect by attaching a soundproofing material, a sound absorbing material, or the like to the covers 101 and 102 and the control units 103 and 104. Also, the covers 101 and 102 may be made disassemblable, or openings may be provided at arbitrary positions of the covers 101 and 102. Further, when openings are provided in the covers 101 and 102, doors may be attached to the openings.

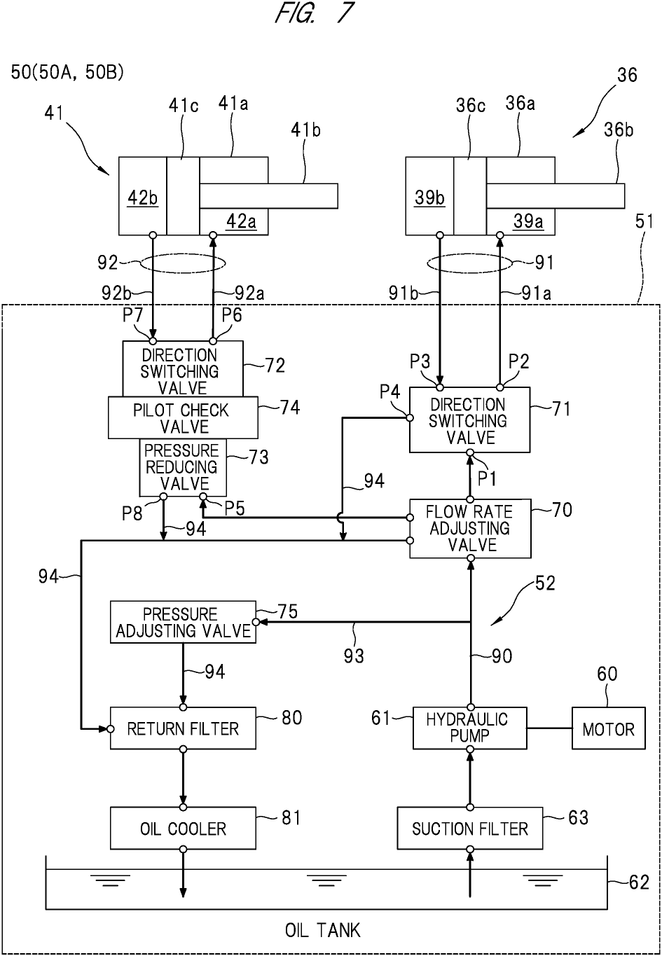

In the foregoing, the invention made by the inventors of this application has been concretely described based on the embodiment. However, it is needless to say that the present invention is not limited to the above-described embodiment and various modifications can be made within the range not departing from the gist thereof. For example, the hydraulic devices included in the hydraulic device group 51 arranged inside the bed 10 are not limited to the hydraulic devices shown in FIG. 4. FIG. 7 is a system diagram showing a modification of the configuration of the hydraulic system 50.

In the hydraulic system 50 shown in FIG. 7, a pressure reducing valve 73 and a pilot check valve 74 are provided between the flow rate adjusting valve 70 and the direction switching valve 72 for moving apparatus.

The pressure reducing valve 73 adjusts the pressure of hydraulic fluid supplied to the hydraulic cylinder 41 through the direction switching valve 72 to a set pressure.

The pilot check valve 74 holds hydraulic oil in the pipe 92 for moving apparatus as required. For example, in the injection process described above, it is necessary to maintain the state where the tip of the injection nozzle 32 is in contact with the sprue bush of the mold 22. At this time, the pilot check valve 74 is closed to hold the hydraulic fluid in the pipe 92 for moving apparatus. From another point of view, the discharge of hydraulic oil from the hydraulic cylinder 41 is temporarily restricted.

Even in the hydraulic system 50 (FIG. 4) in which a valve corresponding to the pilot check valve 74 is not provided, it is possible to maintain the state where the tip of the injection nozzle 32 is in contact with the sprue bush of the mold 22 by continuing to actuate the hydraulic pump 61.

The injection apparatus 30 can be replaced with an injection apparatus (resin injection apparatus) that injects molten resin into the molds 21 and 22 attached to the mold clamping apparatus 20.

The injection molding machine 1 according to the embodiment described above is provided with two sets of the injection apparatus 30 and the moving apparatus 40. Alternatively, an embodiment in which one set of injection apparatus and moving apparatus is provided is also possible. Namely, the present invention can also be applied to a single injection molding machine, and the same effects as those described above can be obtained when applied.

What is claimed is:

1. An injection molding machine comprising:
a bed;
a mold clamping apparatus provided on the bed;
an injection apparatus provided so as to be movable on the bed;
a moving apparatus configured to move the injection apparatus; and
a hydraulic system configured to actuate the injection apparatus and the moving apparatus,
wherein the hydraulic system is provided with a hydraulic device group including a motor, a hydraulic pump, an oil tank, oil filters, and valves, and
wherein the hydraulic device group is arranged inside the bed.

2. The injection molding machine according to claim 1,
wherein the bed includes a top plate on which the mold clamping apparatus, the injection apparatus, and the moving apparatus are mounted and a plurality of support legs configured to support the top plate, and
wherein the hydraulic device group is arranged below the top plate and inside the support legs.

3. The injection molding machine according to claim 2,
wherein the hydraulic device group is arranged below a region of the top plate where the injection apparatus is mounted.

4. The injection molding machine according to claim 2,
wherein a pair of covers facing with the hydraulic device group interposed therebetween are provided on both sides of the top plate.

5. The injection molding machine according to claim 4, further comprising:
a control unit provided between one end side of one cover in a longitudinal direction and one end side of the other cover in the longitudinal direction,
wherein three sides of a space below the top plate are closed by the pair of covers and the control unit.

6. The injection molding machine according to claim 1,
wherein the hydraulic system further includes:
a first flow path for supplying hydraulic fluid to the injection apparatus and recovering the hydraulic fluid from the injection apparatus; and
a second flow path for supplying hydraulic fluid to the moving apparatus and recovering the hydraulic fluid from the moving apparatus, and
wherein the valves constituting the hydraulic device group include:
a flow rate adjusting valve configured to distribute hydraulic fluid delivered from the hydraulic pump to the first flow path and the second flow path;
a first direction switching valve provided on the first flow path; and
a second direction switching valve provided on the second flow path.

7. The injection molding machine according to claim 6,
wherein the valves constituting the hydraulic device group further include a pressure adjusting valve configured to adjust a pressure of the hydraulic fluid supplied to the flow rate adjusting valve.

8. The injection molding machine according to claim 7,
wherein the oil filters constituting the hydraulic device group include:
a first oil filter provided between the oil tank and the hydraulic pump; and
a second oil filter provided between the pressure adjusting valve and the oil tank.

9. The injection molding machine according to claim 1, comprising:
the one injection apparatus as a first injection apparatus and the one moving apparatus as a first moving apparatus provided on the bed;
the other one injection apparatus as a second injection apparatus and the other one moving apparatus as a second moving apparatus provided on the bed;
the one hydraulic system as a first hydraulic system for actuating the first injection apparatus and the first moving apparatus; and
the other one hydraulic system as a second hydraulic system for actuating the second injection apparatus and the second moving apparatus,
wherein the first injection apparatus and the first moving apparatus are arranged in parallel to the second injection apparatus and the second moving apparatus on the bed.
